(19) United States
(12) Patent Application Publication
(10) Pub. No.: US 2026/0228632 A1
(43) Pub. Date: Aug. 6, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yuichi NAKADA, Kanagawa (JP)

(21) Appl. No.: 19/464,774

(22) Filed: Jan. 30, 2026

(30) Foreign Application Priority Data
Feb. 4, 2025 (JP) 2025-017096

(51) Int. Cl. G06N 20/00; G06T 15/20

(52) U.S. Cl. CPC G06N 20/00; G06T 15/20

(57) ABSTRACT

To estimate three-dimensional information with which a virtual viewpoint image having a perceived resolution corresponding to that of captured images can be generated, while restricting a learning parameter number for estimating three-dimensional information. An image processing apparatus according to the present disclosure obtains a plurality of captured images obtained by performing image capturing on an object from a plurality of directions, obtains the amount of blur of the object, sets a learning model representing three-dimensional information on the object on a basis of the amount of blur of the object, and performs the learning of the learning model using the captured images.

### BACKGROUND

### Field of the Technology

The present disclosure relates to a technique of estimating three-dimensional information about a space including an object.

### Description of the Related Art

There is a technique of estimating information about a space including an object (hereinafter, will be referred to as “three-dimensional information”) by using images obtained by performing image capturing on the object from various directions (hereinafter, will be referred to as “captured images”). There is also a technique of generating an image corresponding to a representation of an object viewed from a given virtual viewpoint (hereinafter, will be referred to as “virtual viewpoint image”) by using three-dimensional information.

Japanese Patent Laid-Open No. 2023-66705 (hereinafter, will be referred to as “Patent Literature 1”) discloses a technique of learning, in the form of three-dimensional information, radiance fields that represent a color and a density corresponding to a position and a direction in a space including an object by using captured images as training images. Patent Literature 1 also discloses a technique of generating a virtual viewpoint image through volume rendering using the radiance fields estimated through the learning. Specifically, in the technique disclosed in Patent Literature 1 (hereinafter, will be referred to as “related art”), learning parameters corresponding to the radiance fields are calculated by sampling a point on a ray corresponding to each pixel on a training image and performing machine learning. More specifically, in the calculation, a sampling density within a range of a depth of field is made higher than a sampling density out of the range of the depth of field, for rays corresponding to the pixel on the training image. The related art controls the sampling density on a basis of the depth of field, so as to improve the accuracy of estimation of the radiance fields of the space corresponding to the object within the range of the depth of field while restricting the amount of computation for estimating the radiance fields, and consequently, the quality of the virtual viewpoint image is improved.

### SUMMARY

The related art may generate a virtual viewpoint image having a perceived resolution at the same level of the captured images by using a learning model having a predetermined number of learning parameters (hereinafter, will be referred to as “learning parameter number”). As a result, if the perceived resolution of a captured image reduces due to a blur or the like caused by the motion of a target object, the perceived resolution of the resulting virtual viewpoint image is limited by the perceived resolution of the captured image while the learning parameter number is not changed. That is, a problem of the related art is that a reduction in perceived resolution of a captured image makes the amount of computation needed to estimate the three-dimensional information and the amount of information of the three-dimensional information excessive with respect to the perceived resolution of the resulting virtual viewpoint image.

Hence, the present disclosure is directed to providing a technique of restricting the amount of computation needed to estimate three-dimensional information for generating a virtual viewpoint image having a perceived resolution at the same level of captured images and restricting the amount of information of the three-dimensional information.

An image processing apparatus according to the present disclosure includes: one or more hardware processors; and one or more memories storing one or more programs configured to be executed by the one or more hardware processors, the one or more programs including instructions for: obtaining a plurality of captured images obtained by performing image capturing on an object from a plurality of directions; obtaining an amount of blur of the object; setting a learning model representing three-dimensional information on the object on a basis of the amount of blur of the object; and performing learning of the learning model using the captured images.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of the configuration of an image processing system according to a first embodiment;

FIG. 2 is a block diagram illustrating an example of the hardware configuration of an image processing apparatus according to a first embodiment;

FIG. 3 is a block diagram illustrating an example of the functional configuration in the image processing apparatus according to the first embodiment;

FIG. 4 is a flowchart illustrating an example of a processing flow in the image processing apparatus according to the first embodiment;

FIG. 5A is a diagram illustrating an example of the disposition of image capturing devices according to the first embodiment, and FIGS. 5B to 5D are diagrams illustrating an example of captured images;

FIG. 6 is a diagram illustrating an example of an approximate shape obtained by a shape obtaining unit according to the first embodiment;

FIG. 7 is a flowchart illustrating an example of the flow of the process of obtaining amounts of blur by an amount-of-blur obtaining unit according to the first embodiment;

FIG. 8 is a diagram for describing an example of the amount of movement of the approximate shape according to the first embodiment;

FIG. 9 is a flowchart illustrating an example of the flow of the process of setting a learning model by a model setting unit according to the first embodiment;

FIGS. 10A and 10B are a diagram and a table for describing an example of the process of setting the learning model by the model setting unit according to the first embodiment;

FIGS. 11A and 11B are diagrams illustrating an example of learning target regions according to the first embodiment;

FIGS. 12A and 12B are a diagram and a table for describing an example of the process of setting the learning model by the model setting unit according to a modification of the first embodiment;

FIG. 13 is a flowchart illustrating an example of the flow of the process of obtaining amounts of blur by an amount-of-blur obtaining unit according to a second embodiment;

FIG. 14 is a diagram for describing an example of a movement vector of an approximate shape according to the second embodiment;

FIG. 15 is a flowchart illustrating an example of the flow of the process of setting a learning model by a model setting unit according to the second embodiment;

FIGS. 16A to 16D are tables showing examples of a look-up table used by the model setting unit according to the second embodiment to set grid spacings; and

FIGS. 17A and 17B are diagrams for describing an example of the process of setting the learning model by the model setting unit according to a modification of the second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

Hereinafter, embodiments according to the technique of the present disclosure will be described with reference to the drawings. Note that the following embodiments do not necessarily limit means for solving the problems relating to the technique according to the present disclosure. All of the combinations of features described in the following embodiments are not essential in the means for solving the problems relating to the technique according to the present disclosure.

### First Embodiment

In the present embodiment, an aspect in which radiance fields corresponding to a space including an object are learned on a basis of data on captured images obtained by performing image capturing on the object from various directions using a plurality of image capturing devices (hereinafter, will be referred to as “captured image data”) will be described. Specifically, the above-described learning according to the present embodiment is performed on a learning model that is set on a basis of the amounts of blur of the representation of the object in the captured images.

### <Configuration of Image Processing System>

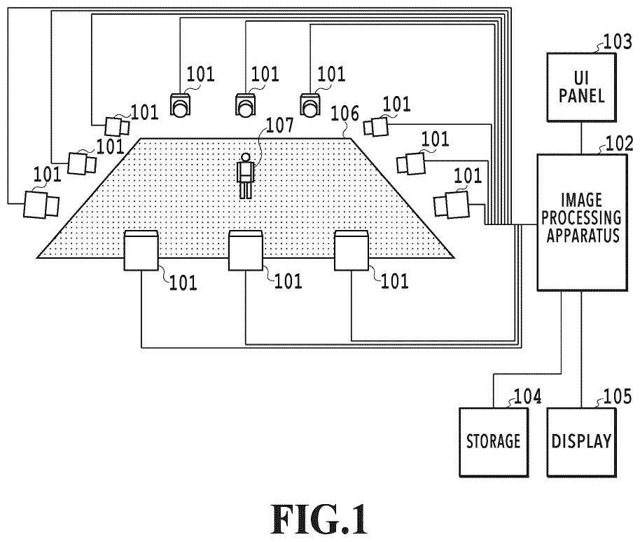

FIG. 1 is a diagram illustrating an example of the configuration of an image processing system according to a first embodiment. The image processing system includes a plurality of image capturing devices 101, an image processing apparatus 102, a user interface (hereinafter, will be denoted as “UI”) panel 103, a storage 104, and a display 105. The plurality of image capturing devices 101 are each constituted by a digital still camera, a digital video camera, or the like, and are disposed at locations that are different from one another. Each of the image capturing devices 101 performs image capturing on an object 107, which is present in an image capturing region 106, from various directions in a mutually synchronized manner according to an image capturing conditions that are determined in advance, and outputs captured image data obtained through the image capturing to the image processing apparatus 102. Note that the mutually-synchronized image capturing does not mean simultaneity but means image capturing undergoing synchronous processing. That is, the mutually-synchronized image capturing need not be image capturing performed at exactly the same time point. The mutually-synchronized image capturing also includes image capturing that is performed at substantially the same time points. Captured image data obtained through the image capturing by an image capturing device 101 may be data on a still image, data on a moving image, or data on both a still image and a moving image. In the following description, it is assumed that the term “image” includes both meanings of “still image” and “moving image,” unless otherwise stated.

The image processing apparatus 102 obtains a plurality of captured image data items output from the plurality of image capturing devices 101 and, by using the plurality of obtained captured image data items, performs learning of information about a three-dimensional shape and colors (three-dimensional information) of a space including the object 107 present in the image capturing region 106. On a basis of the three-dimensional information obtained as the result of the learning (hereinafter, will be referred to as “learned three-dimensional information”), the image processing apparatus 102 generates a virtual viewpoint image.

The present embodiment will be described on the assumption that, as an example, three-dimensional information to be learned is a function representing radiance fields that are configured by a multi-layer perceptron (MLP). However, how to represent the three-dimensional information to be learned differs according to content to be learned. Specifically, for example, the three-dimensional information may be three-dimensional information represented by means of InstantNGP. The three-dimensional information is not limited to one configured by a multi-layer perceptron. The three-dimensional information may be three-dimensional information represented by means of Plenoxels, Tensorial Radiance Fields (TensoRF), or the like, which explicitly represents three dimensions. The three-dimensional information may be three-dimensional information represented with, for example, a NeuS, which uses signed distance field (SDF) to yield an improved accuracy of the estimation of a shape. The three-dimensional information may also be three-dimensional information represented by one of various methods, such as three-dimensional information represented by means of, for example, 3D Gaussian Splatting, which represents three dimensions with a set of points with spatial extent.

The present embodiment will be described on the assumption that plurality of image capturing devices 101 are connected to the image processing apparatus 102, as illustrated in FIG. 1. However, how to connect the image capturing devices 101 to the image processing apparatus 102 is not limited to this. Specifically, for example, the plurality of image capturing devices 101 may be cascaded by connecting adjacent image capturing devices 101 together, and at least one of the plurality of image capturing devices 101 may be connected to the image processing apparatus 102.

The UI panel 103 includes a display device such as a liquid crystal panel and displays, on the display device, a graphical user interface (GUI) for presenting information such as the image capturing conditions for the image capturing devices 101, processing settings for the image processing apparatus 102, and the like, to a user. The UI panel 103 may also include an input device such as a touch-sensitive panel or buttons. In this case, the UI panel 103 accepts an instruction from the user pertaining to the changing of the above-described image capturing conditions or processing settings. The input device may be provided separately from the UI panel 103, such as a mouse or a keyboard.

The storage 104 is constituted by a hard disk drive or the like. The storage 104 stores data on the virtual viewpoint image output by the image processing apparatus 102. In a case where the image processing apparatus 102 outputs the three-dimensional information, the storage 104 may store the three-dimensional information output from the image processing apparatus 102. The display 105 is constituted by a liquid crystal display or the like. The display 105 obtains an image signal indicating the virtual viewpoint image output from the image processing apparatus 102 and displays the virtual viewpoint image corresponding to the image signal. In the case where the image processing apparatus 102 outputs the image signal indicating the three-dimensional information, the display 105 may obtain the image signal indicating the three-dimensional information output from the image processing apparatus 102 and display an image corresponding to the image signal. The image capturing region 106 is a three-dimensional space surrounded by the plurality of image capturing devices 101 that are installed in a studio or the like. The frame drawn with solid lines in FIG. 1 indicates the outline of the image capturing region 106 on a floor surface.

### <Hardware Configuration of Image Processing Apparatus>

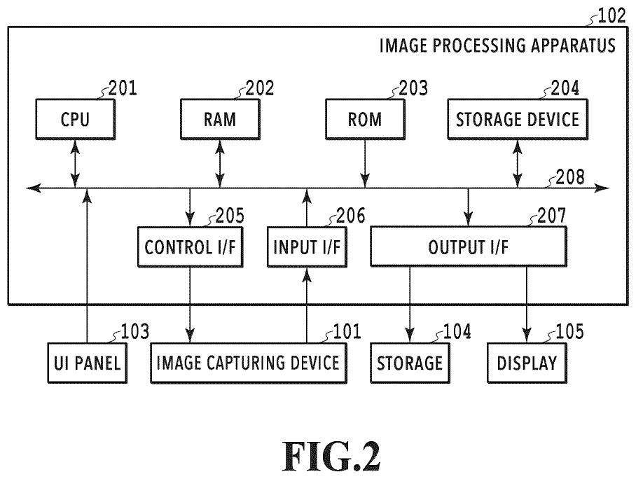

FIG. 2 is a block diagram illustrating an example of the hardware configuration of the image processing apparatus 102 according to the first embodiment. As its hardware configuration, the image processing apparatus 102 includes a CPU 201, a RAM 202, a ROM 203, a storage device 204, a control interface (hereinafter, will be denoted as “I/F”) 205, an input I/F 206, an output I/F 207, and a main bus 208. The CPU 201 is a processor that integrally controls the components of the image processing apparatus 102. The RAM 202 functions as a main memory, a work area, and the like for the CPU 201. The ROM 203 stores a group of programs to be executed by the CPU 201. The storage device 204 is constituted by a hard disk drive or the like. The storage device 204 stores an application program to be executed by the CPU 201, various types of data to be used in processing by the CPU 201.

The control I/F 205 is connected to the image capturing devices 101. The control I/F 205 is a communication interface for setting the image capturing conditions for the image capturing devices 101 and performing control of starting, stopping, and the like of the image capturing. The input I/F 206 is a communication interface based on serial bus or the like, such as Serial Digital Interface (SDI) or High-Definition Multimedia Interface® (HDMI®). Via the input I/F 206, the captured image data items output from the image capturing devices 101 are obtained. The output I/F 207 is a communication interface based on a serial bus or the like, such as Universal Serial Bus (USB) or DisplayPort®. Via the output I/F 207, data or an image signal about the virtual viewpoint image or the like is output to the storage 104 or the display 105. The main bus 208 is a transmission channel that connects the above-described components in the hardware configuration included in the image processing apparatus 102 to one another so that the components can communicate with one another.

### <Functional Configuration of Image Processing Apparatus>

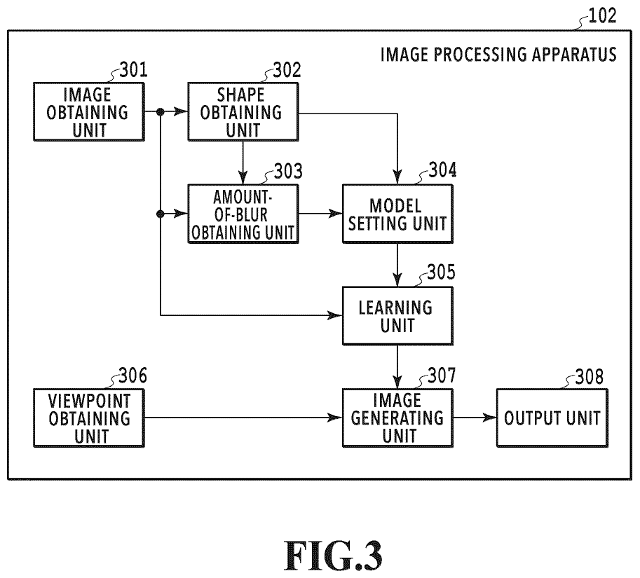

FIG. 3 is a block diagram illustrating an example of the functional configuration in the image processing apparatus 102 according to the first embodiment. The image processing apparatus 102 includes an image obtaining unit 301, a shape obtaining unit 302, an amount-of-blur obtaining unit 303, a model setting unit 304, a learning unit 305, a viewpoint obtaining unit 306, an image generating unit 307, and an output unit 308. The units included in the image processing apparatus 102 as the functional configuration are implemented by the CPU 201 executing a program stored in the ROM 203 or the like, with the RAM 202 as a working memory. Note that all of the processes performed by components included in the image processing apparatus 102 as its functional configuration, which will be described below, need not necessarily be executed by the CPU 201. The image processing apparatus 102 may be configured such that some or all of the processes are executed by one or more processing circuits other than the CPU 201.

The image obtaining unit 301 obtains the captured image data items that the image capturing devices 101 obtain by performing the image capturing on the image capturing region 106. The image obtaining unit 301 also obtains information about settings of the image capturing for the image capturing devices 101 corresponding to the obtained captured image data items (hereinafter, will be referred to as “image capturing settings”) and obtains parameters of the image capturing (hereinafter, will be referred to as “image capturing parameters”). On a basis of the captured image data items and image capturing parameters obtained by the image obtaining unit 301, the shape obtaining unit 302 obtains an approximate shape of the object 107.

On a basis of the image capturing parameters and the information about the image capturing settings obtained by the image obtaining unit 301 and the approximate shape of the object 107 obtained by the shape obtaining unit 302, the amount-of-blur obtaining unit 303 obtains the amount of blur of a representation of the object 107 in a captured image (hereinafter, will be denoted as “amount of blur of the object” or simply denoted as “amount of blur”). On a basis of the approximate shape of the object 107 obtained by the shape obtaining unit 302 and the amount of blur of the object 107 obtained by the amount-of-blur obtaining unit 303, the model setting unit 304 sets a learning model corresponding to a space including the object 107.

On a basis of the captured image data items and image capturing parameters obtained by the image obtaining unit 301 and the learning model set by the model setting unit 304, the learning unit 305 learns information about radiance fields of the space including the object 107 (the three-dimensional information). Here, the three-dimensional information is, for example, network parameters in a learning model constituted by a multi-layer perceptron that represents the radiance fields of the space including the object 107.

The viewpoint obtaining unit 306 obtains information about a virtual viewpoint (hereinafter, will be referred to as “virtual viewpoint information”). Here, the virtual viewpoint information is information indicating the position of a virtual viewpoint and a viewing direction at the virtual viewpoint. The virtual viewpoint information is information equivalent to image capturing parameters of a virtual image capturing device (hereinafter, will be referred to as “virtual camera”) disposed at the virtual viewpoint (hereinafter, will be referred to as “virtual camera parameters”). The image generating unit 307 generates the virtual viewpoint image using the learned three-dimensional information obtained as the result of the learning by the learning unit 305, that is, the learning model that has been subjected to the learning and is the information about the radiance fields and the virtual camera parameters obtained by the viewpoint obtaining unit 306. Specifically, the image generating unit 307 performs volume rendering using the learned three-dimensional information to generate a virtual viewpoint image corresponding to the appearance from a virtual viewpoint indicated by the virtual camera parameters. The following will be described with the learning model that has been subjected to the learning denoted as “learned model.”

The output unit 308 outputs data on the virtual viewpoint image generated by the image generating unit 307 to the storage 104 to cause the storage 104 to store the data. The output unit 308 may output the virtual viewpoint image to the display 105 in the form of an image signal to cause the display 105 to display the virtual viewpoint image. The output unit 308 may also output the learned three-dimensional information obtained as the result of the learning by the learning unit 305, that is, the learned model that is the information about the radiance fields, to the storage 104 or the like.

### <Operation of Image Processing Apparatus>

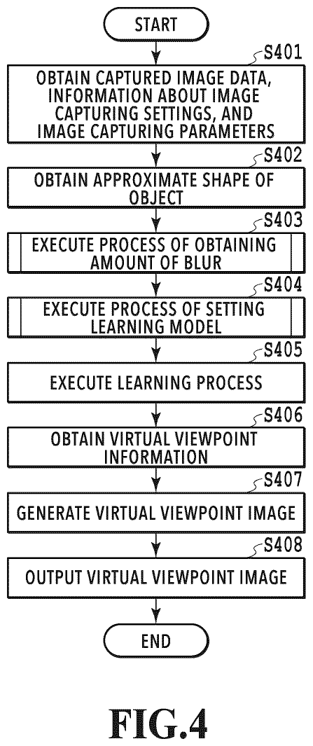

FIG. 4 is a flowchart illustrating an example of a processing flow in the image processing apparatus 102 according to the first embodiment. Hereinafter, processing steps (processes) are each denoted with a reference numeral prepended with “S.” In the case where the image capturing devices 101 output data on moving images as the captured image data items, the image processing apparatus 102 execute the processes in the flowchart repeatedly every time the image capturing devices 101 output data items on frames included in the moving images obtained through the synchronized image capturing.

First, in S401, the image obtaining unit 301 obtains a plurality of captured image data items obtained through the image capturing, and obtains the image capturing parameters and the information about the image capturing settings corresponding to the captured image data items. Specifically, for example, the captured image data items and the information about the image capturing settings are obtained from the image capturing devices 101 via the input I/F 206, and the image capturing parameters are calculated beforehand through the execution of calibration or the like and stored in the storage device 204, from which the image capturing parameters are read out and obtained. The captured image data items and image capturing parameters obtained in S401 are retained in the RAM 202.

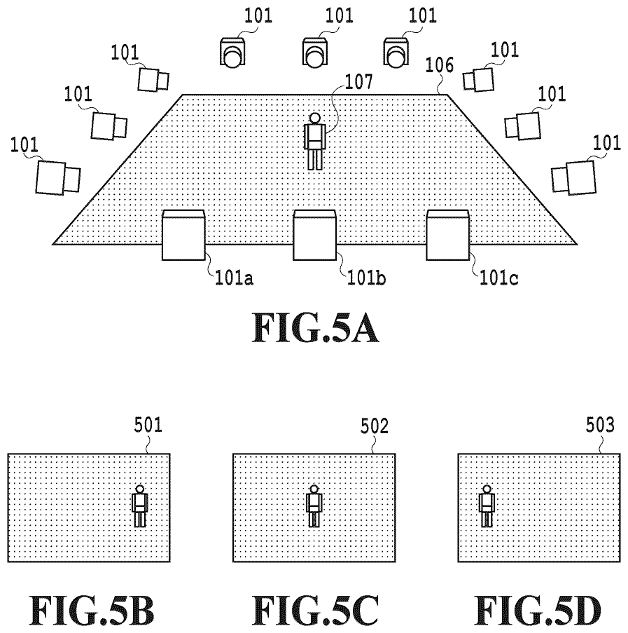

FIG. 5A is a diagram illustrating an example of the disposition of the image capturing devices 101 according to the first embodiment, and FIGS. 5B to 5D are diagrams illustrating an example of captured images 501 to 503 that are obtained through image capturing by image capturing devices 101a to 101c. The plurality of image capturing devices 101 are disposed such that the image capturing devices 101 are capable of performing image capturing on the object 107 present in the image capturing region 106 from various directions. Note that the image capturing devices 101a, 101b, and 101c illustrated in FIG. 5A are the same as the other image capturing devices 101. FIG. 5B illustrates an example of the captured image 501 obtained through image capturing by the image capturing device 101a, FIG. 5C illustrates an example of the captured image 502 obtained through image capturing by the image capturing device 101b, and FIG. 5D illustrates an example of the captured image 503 obtained through image capturing by the image capturing devices 101c.

After S401, in S402, the shape obtaining unit 302 obtains the approximate shape of the object 107, which is included in the captured images obtained in S401 in the form of representations. Specifically, for example, in S402, the shape obtaining unit 302 first obtains silhouette images corresponding to the captured images obtained in S401. Here, the silhouette image is an image indicating a region including the representation of the object 107 in a captured image. For example, the shape obtaining unit 302 first obtains, in the state where the object 107 is absent, data items on background images obtained by the image capturing devices 101 performing image capturing on only the background (hereinafter, will be referred to as “background image data items”). For example, the background image data items may be captured in advance by the image capturing devices 101 and stored in advance in the storage device 204 or the like and then read out and obtained by the shape obtaining unit 302. The shape obtaining unit 302 then obtains the silhouette images of the object 107 on a basis of the difference between the captured image data items corresponding to the image capturing devices 101 and the background image data items corresponding to the captured image data items. The method for obtaining the silhouette images of the object 107 is known, and the detailed description thereof will be omitted.

In S402, the shape obtaining unit 302 then obtains the approximate shape of the object 107 on a basis of the image capturing parameters obtained in S401 and the silhouette images obtained through the above-described process in S402. Specifically, for example, the shape obtaining unit 302 first projects voxels included in a set of voxels corresponding to the image capturing region 106 onto the silhouette images on a basis of the image capturing parameters obtained in S401. The shape obtaining unit 302 then obtains a set of voxels that are projected, for all the silhouette images, onto their silhouette regions that correspond to the region of the representation of the object 107, as the approximate shape of the object. The method for obtaining the approximate shape of the object 107 by visual hull or the like, which uses silhouette images, is known, and the detailed description thereof will be omitted. The method for obtaining the approximate shape of the object 107 is not limited to the visual hull. The method may be any method such as a stereo matching method.

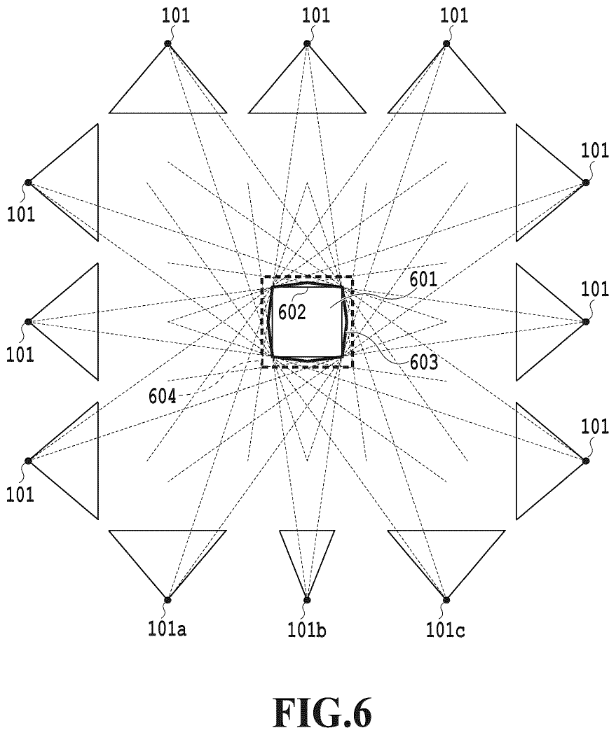

FIG. 6 is a diagram illustrating an example of an approximate shape obtained by the shape obtaining unit 302 according to the first embodiment. In FIG. 6, the rectangle enclosed by thin solid lines indicates an actual outline 602 of an object 601, and the polygon enclosed by thick solid lines indicates the outline of an approximate shape 603 of the object 601 obtained by the shape obtaining unit 302. The polygon enclosed by thick broken lines indicates the outline of a space to be subjected to the learning by the learning unit 305 (hereinafter, will be referred to as “learning target region 604”).

After S402, in S403, the amount-of-blur obtaining unit 303 executes the process of obtaining the amount of blur. Specifically, for example, the amount-of-blur obtaining unit 303 obtains the amount of blur of the object 107 on a basis of the image capturing parameters and the information about the image capturing settings obtained in S401 and the approximate shape of the object 107 obtained in S402. For example, the amount of blur of the object 107 may be calculated on a basis of the amounts of movement per exposure time of the reference point of the approximate shape projected onto the captured images. The process of obtaining the amount of blur by the amount-of-blur obtaining unit 303 will be described in detail later.

Next, in S404, the model setting unit 304 executes the process of setting a learning model that is a target of the learning by the learning unit 305. Specifically, for example, on a basis of the approximate shape of the object 107 obtained in S402 and the amount of blur of the object 107 obtained in S403, the model setting unit 304 sets a learning model that corresponds to a space to be learned including the object 107 (the learning target region). The process of setting the learning model by the model setting unit 304 will be described in detail later.

Next, in S405, the learning unit 305 executes the process of learning the three-dimensional information. Specifically, for example, on a basis of the captured image data items and image capturing parameters obtained in S401, the learning unit 305 performs the learning of a learning model that is set in the space to be learned including the object 107 (the learning target region) in S404 and represents radiance fields. The present embodiment will be described on the assumption that, as an example, the radiance fields are represented by a function that takes, as an input, information indicating a position in the image capturing region 106 that is encoded and a direction and outputs information indicating a density and a color, and are represented by a learning model that is constituted by the function in the form of an MLP. That is, as an example, the MLP according to the present embodiment is configured to calculate a color and a density in accordance with connection weights between nodes on a basis of information indicating a position and a direction in the image capturing region 106 that is encoded, which is input into its input layer, and to output information indicating the result of the calculation from its output layer.

The learning of the learning model representing the radiance fields is performed on a basis of the differences between values of pixels obtained by the volume rendering using the image capturing parameters and the radiance fields (hereinafter, will be referred to as “rendered values”) and values of pixels in each captured image that correspond to the pixels obtained by the volume rendering (pixel values). Specifically, the learning unit 305 performs the learning of the learning model representing the radiance fields by updating the value of the connection weights of the MLP representing the radiance fields in such a manner as to decrease the differences between the pixel values. For example, the learning unit 305 first obtains ray information items corresponding to the pixels in each captured image on a basis of the image capturing parameters. Each of the ray information items includes information indicating the start point and direction of a ray and a color corresponding to the ray. Here, the color corresponding to the ray is a value of a pixel in the captured image corresponding to the ray (pixel value). The learning unit 305 then sets, for each ray information item, a plurality of sampling points on the corresponding ray, obtains information indicating a density and a color corresponding to a position and the direction of the ray on each of the sampling points on a basis of the MLP representing the radiance fields, and calculates a rendered value corresponding to the ray. Specifically, for example, the learning unit 305 calculates a rendered value corresponding to each ray using Equation (1) and Equation (2).

$$C ( r ) = {\sum }_{i = 1}^{N} {T}_{i} ( 1 - exp ( - {σ}_{i} {δ}_{i} ) ) {c}_{i} \qquad Equation ( 1 )$$

$${T}_{i} = exp ( - {\sum }_{j = 1}^{i - 1} - {σ}_{j} {δ}_{j} ) \qquad Equation ( 2 )$$

Here, C(r) denotes a rendered value corresponding to a ray r, i denotes the index of the sampling points, σᵢ denotes a density at a sampling point i, cᵢ is a color at the sampling point i, and δᵢ denotes the distance from the sampling point i to the next sampling point (i+1). Tᵢ is an accumulated transmittance from the start point of the ray to the sampling point i. The learning unit 305 updates the values of the connection weights of the MLP in such a manner as to decrease the squared Euclidean distance between the rendered value C(r) corresponding to the ray r and a color corresponding to the ray r, that is, the value of the pixel in the captured image corresponding to the ray r (pixel value). The process of S405 corresponds to an error calculation process and an error propagation process in the deep learning.

After S405, in S406, the viewpoint obtaining unit 306 obtains, as the virtual viewpoint information, a virtual camera parameters that are set on a basis of an instruction from a user using the UI panel 103. The method for obtaining the virtual camera parameters by the viewpoint obtaining unit 306 is not limited to the above-described method. For example, the viewpoint obtaining unit 306 may obtain the virtual camera parameters by reading out the virtual camera parameters that are set beforehand and stored in the storage device 204 or the like.

Next, in S407, the image generating unit 307 generates the virtual viewpoint image using the virtual camera parameters obtained in S406 and the learned three-dimensional information obtained as the result of the learning process in S405, that is, the learned model representing the radiance fields. Specifically, the image generating unit 307 performs the volume rendering on the learned three-dimensional information, which is the learned model representing the radiance fields, to generate a virtual viewpoint image corresponding to the appearance from a virtual viewpoint indicated by the virtual camera parameters.

Next, in S408, the output unit 308 outputs the virtual viewpoint image generated in S407. Specifically, for example, the output unit 308 outputs data on the virtual viewpoint image or an image signal indicating the virtual viewpoint image to the storage 104, the display 105, or the like via the output I/F 207. After S408, the image processing apparatus 102 finishes the processes in the flowchart illustrated in FIG. 4. Note that, in a case where the image capturing devices 101 output data items on moving images as the captured image data items as described above, the image processing apparatus 102 returns to S401 after S408 to repeatedly execute the processes in the flowchart on the captured image data item of the next frame.

### <Process of Obtaining Amount of Blur>

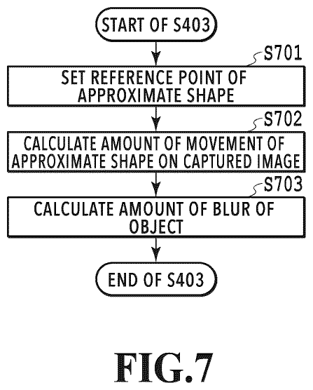

FIG. 7 is a flowchart illustrating an example of the flow of the process of obtaining an amount of blur by the amount-of-blur obtaining unit 303 according to the first embodiment. FIG. 7 is a flowchart illustrating an example of a detailed processing flow of S403 illustrated in FIG. 4. In S403, the amount of blur of the object is obtained on a basis of the image capturing parameters and the information about the image capturing settings obtained in S401 and the approximate shape of the object obtained in S402. After S402, first, in S701, the amount-of-blur obtaining unit 303 sets a reference point to the approximate shape of the object obtained in S402. The present embodiment will be described on the assumption that, as an example, the amount-of-blur obtaining unit 303 sets the position of the center of gravity of the approximate shape as the reference point. However, the reference point may be any position inside the approximate shape, such as the center of a rectangular cuboid shape that includes the approximate shape.

Next, in S702, the amount-of-blur obtaining unit 303 calculates the amount of movement of the approximate shape on the captured image using the image capturing parameters obtained in S401 and the reference point set in S701. Specifically, for example, the amount-of-blur obtaining unit 303 calculates the amount of movement of the approximate shape on a basis of a position corresponding to the reference point of the approximate shape in a frame of interest and a position corresponding to the reference point of the approximate shape in a frame immediately preceding the frame of interest (hereinafter, will be referred to as “previous frame”). More specifically, for example, the amount-of-blur obtaining unit 303 first specifies an image capturing device 101 that includes, in the angle of view, the reference point in the frame of interest and the reference point in the previous frame. For example, the amount-of-blur obtaining unit 303 judges that the reference point is included in the angle of view in a case where the reference point projected using the image capturing parameters is included in the captured image. Then, on the image capturing device 101 that includes, in the angle of view, the reference points in the frame of interest and the previous frame, the amount-of-blur obtaining unit 303 calculates the difference between the positions of the two reference points projected onto the captured image using the image capturing parameters, as the amount of movement of the approximate shape corresponding to the reference point in the captured image. For example, the amount of movement of the approximate shape corresponding to the reference point in the captured image may be calculated using Equation (3) shown below.

$${m}_{i , j} = \vert {p}_{i , j} - {p}_{i - 1 , j} \vert \qquad Equation ( 3 )$$

Here, m_{i,j} denotes the amount of movement of the approximate shape corresponding to an image capturing devices 101 having an index of j (hereinafter, will be denoted as “image capturing device j”) in the ith frame that is the frame of interest (hereinafter, will be denoted as “frame i”). In addition, p_{i,j} denotes the coordinates of a point at which the reference point in the frame i is projected to the image capturing device j, and p_{i-1,j} denotes the coordinates of a point at which the reference point in the (i−1)th frame, which is the previous frame (a frame i−1), is projected to the image capturing device j.

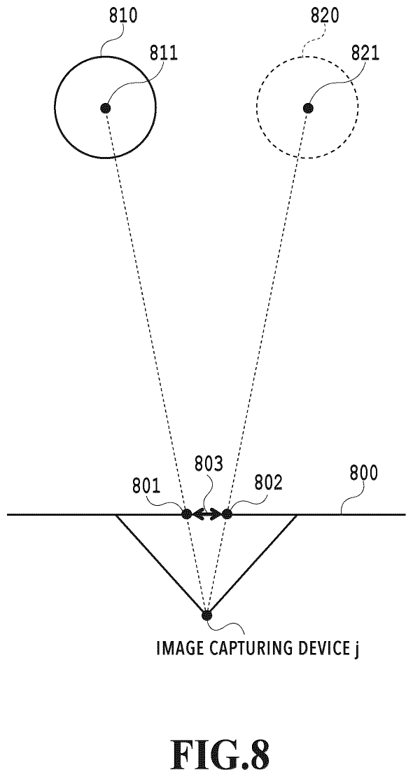

FIG. 8 is a diagram for describing an example of the amount of movement of the approximate shape according to the first embodiment. In FIG. 8, the circle drawn with a solid line represents an approximate shape 810 of an object at a time point corresponding to the frame of interest (frame i), and the point drawn in the approximate shape 810 represents a reference point 811 of the approximate shape 810. Likewise, the circle drawn with a broken line represents an approximate shape 820 of the object at a time point corresponding to the previous frame (frame i−1), and the point drawn in the approximate shape 820 represents a reference point 821 of the approximate shape 820. A straight line drawn with a solid line represents an image plane 800 of a captured image obtained through image capturing by the image capturing device j, and points 801 and 802 on the image plane 800 represent the positions at which the reference points 811 and 821 are projected onto the captured image, in this order. A segment 803 from the point 801 to the point 802 on the image plane 800 represents the amount of movement of the approximate shape corresponding to the image capturing device j in the frame i.

After S702, in S703, the amount-of-blur obtaining unit 303 calculates the amount of blur of the object using information on an exposure time and a frame rate that are included in the information about the image capturing settings obtained in S401 and the amount of movement of the approximate shape calculated in S702. For example, the amount of blur of the object may be calculated using Equation (4).

$${b}_{i} = {max}_{j} ( {sfm}_{i , j} ) \qquad Equation ( 4 )$$

Here, bᵢ denotes the amount of blur of the object in the frame i, s denotes an exposure time in the image capturing by the image capturing device j, and f denotes a frame rate in the image capturing by the image capturing device j. max( ) is a function that receives inputs and outputs the maximum value of the inputs. That is, the amount-of-blur obtaining unit 303 obtains, for example, the largest value of the amounts of movement of the approximate shape per exposure time corresponding to the image capturing devices, as the amount of blur bᵢ of the object. After S703, the amount-of-blur obtaining unit 303 finishes the processes in the flowchart illustrated in FIG. 7, that is, the process of S403 illustrated in FIG. 4. Through the process of S403, the amount of blur bᵢ of the object in the frame of interest (frame i) is obtained.

### <Process of Setting Learning Model>

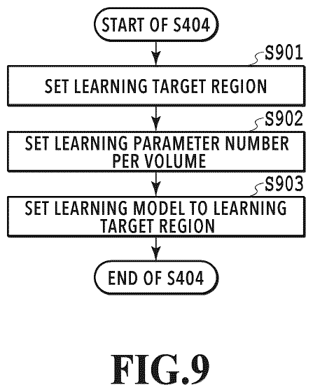

FIG. 9 is a flowchart illustrating an example of the flow of the process of setting a learning model by the model setting unit 304 according to the first embodiment. FIG. 9 is a flowchart illustrating an example of a detailed processing flow of S404 illustrated in FIG. 4. The processes in the flowchart are executed after the process of S403 according to the present embodiment. In S404, the learning model corresponding to the object is set as the learning target region on a basis of the approximate shape of the object obtained in S402 and the amount of blur of the object obtained in S403. In the present embodiment, an aspect in which the model setting unit 304 controls the total number of layers in an intermediate layer of the MLP constituting the learning model in accordance with the amount of blur, as the process of setting the learning model will be described as an example. Specifically, the present embodiment will be described on the assumption that the learning model is constituted by an MLP representing densities (hereinafter, will be referred to as “density MLP”) and an MLP representing colors, and that the model setting unit 304 controls the number of layers in the intermediate layer of the density MLP.

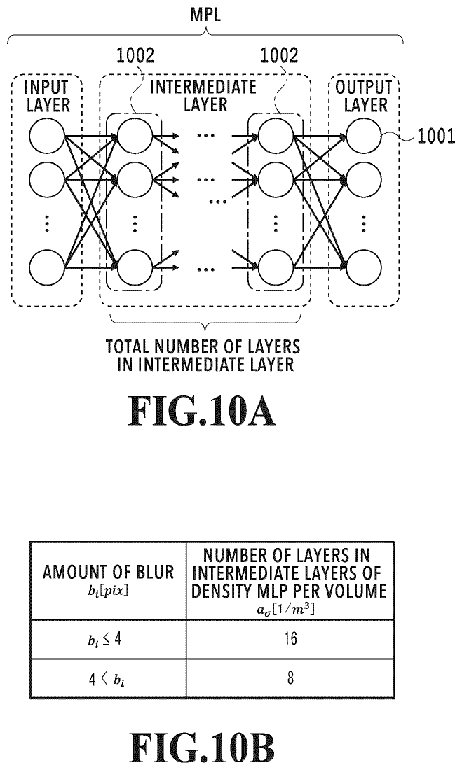

FIGS. 10A and 10B are a diagram and a table for describing an example of the process of setting the learning model by the model setting unit 304 according to the first embodiment. FIG. 10A illustrates an example of an MLP. The MLP includes an input layer including one or more nodes 1001, an intermediate layer including one or more layers 1002 each including one or more nodes 1001, and an output layer including one or more nodes 1001.

After S403, in S901, the model setting unit 304 sets the learning target region. Specifically, the model setting unit 304 sets the region of a rectangular cuboid shape that contains the approximate shape of the object obtained in S402, as the learning target region to which the learning model is to be assigned. The model setting unit 304 may set, as the learning target region, the region of a rectangular cuboid shape that is provided with a predetermined margin relative to the approximate shape of the object or may set, as the learning target region, the region of a smallest rectangular cuboid shape that encloses the approximate shape of the object, with no margin provided. Note that, in FIG. 6, the polygon enclosed by the thick broken lines indicates the outline of the learning target region 604 that is set by the model setting unit 304.

Next, in S902, the model setting unit 304 sets a learning parameter number per volume in the learning model corresponding to the object on a basis of the amount of blur of the object obtained in S403. Specifically, for example, the model setting unit 304 sets the learning parameter number per volume such that the number of layers per volume in the intermediate layer of the density MLP corresponding to the object increases with a decrease in the amount of blur bᵢ of the object. For example, the model setting unit 304 consults a look-up table in which amounts of blur are associated in advance with the number of layers per volume in the intermediate layer of the density MLP. Using the look-up table, the model setting unit 304 determines the number of layers per volume in the intermediate layer of the density MLP corresponding to the object in accordance with the amount of blur of the object. For example, an object for which the amount of blur bᵢ is less than or equal to a predetermined value is defined as an object of a small amount of blur, and an object for which the amount of blur bᵢ is greater than the predetermined value is defined in advance as an object of a large amount of blur.

FIG. 10B illustrates an example of the look-up table used in a case where the model setting unit 304 determines the number of layers per volume in the intermediate layer of the density MLP. For example, as in the look-up table shown in FIG. 10B as an example, an object for which the amount of blur bᵢ is smaller than or equal to 4 pixels (pix) is defined in advance as the object of a small amount of blur. In addition, an object for which the amount of blur bᵢ is larger than 4 pix is defined in advance as the object of a large amount of blur. In a case where the amount of blur bᵢ is smaller than or equal to 4 pix, that is, the amount of blur of the object is small, the model setting unit 304 sets a large value such as “16” as the number of layers per volume in the intermediate layer of the density MLP. In a case where the amount of blur bᵢ is larger than 4 pix, that is, the amount of blur of the object is large, the model setting unit 304 sets a small value such as “8” as the number of layers per volume in the intermediate layer of the density MLP. In the above-described manner, for example, the model setting unit 304 selectively sets any one of the two values as the number of layers per volume in the intermediate layer of the density MLP corresponding to the object, in accordance with the amount of blur of the object.

After S902, in S903, the model setting unit 304 sets the learning model to which the learning parameter number per volume is set in S902 to the learning target region that is set in S901. Specifically, the model setting unit 304 sets a value to which the product of the number of layers per volume in the intermediate layer of the density MLP set in S902 and the volume of the learning target region is rounded, as the total number of layers in the intermediate layer of the density MLP constituting the learning model. After S903, the model setting unit 304 finishes the processes in the flowchart illustrated in FIG. 9, that is, the process of S404 illustrated in FIG. 4. Through the process of S404, a learning model constituted by a density MLP having a large number of layers in its intermediate layer per volume is set to the learning target region corresponding to an object of a small amount of blur. In contrast, a learning model constituted by a density MLP having a small number of layers in its intermediate layer per volume is set to the learning target region corresponding to an object of a large amount of blur.

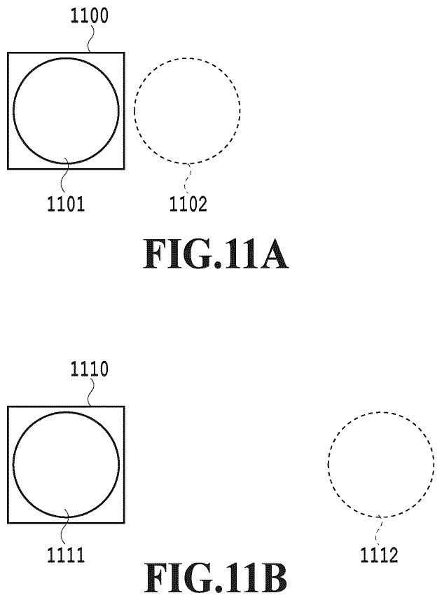

FIGS. 11A and 11B are diagrams illustrating an example of learning target regions 1100 and 1110 that are set by the model setting unit 304 according to the first embodiment. In FIGS. 11A and 11B, the circles drawn with solid lines represent approximate shapes 1101 and 1111 of the object corresponding to the frame of interest. In FIGS. 11A and 11B, the circles drawn with broken lines represent approximate shapes 1102 and 1112 of the object corresponding to the previous frame. For example, to an object for which the amount of movement of the approximate shape is small, that is, to the learning target region 1100 corresponding to an object of a small amount of blur as illustrated in FIG. 11A, a learning model constituted by a density MLP having a large number of layers in its intermediate layer per volume is set. In contrast, to an object for which the amount of movement of the approximate shape is large, that is, to the learning target region 1110 corresponding to an object of a large amount of blur as illustrated in FIG. 11B, a learning model constituted by a density MLP having a small number of layers in its intermediate layer per volume is set.

The learning model set to the learning target region 1100 corresponding to the object of a small amount of blur, which has a large learning parameter number per volume, is capable of estimating the radiance fields, that is, the three-dimensional information at a high resolution. As a result, the representation of an object included in a virtual viewpoint image generated on a basis of the three-dimensional information is of a high resolution as with the representations of an object of a small amount of blur included in the captured images. In contrast, the learning model set to the learning target region 1110 corresponding to the object of a large amount of blur, which has a small learning parameter number per volume, may restrict the amount of computation needed to estimate the three-dimensional information and the amount of information of the three-dimensional information. In this case, the representation of an object included in a virtual viewpoint image generated on a basis of the three-dimensional information is of a low resolution as with the representations of an object of a large amount of blur included in the captured images.

### <Effects Produced by Image Processing Apparatus>

As described above, the image processing apparatus 102 learns the radiance fields of the space including the object 107 on a basis of the plurality of captured image data items obtained through the image capturing of the object 107 from the various directions using the plurality of image capturing devices 101. In particular, in the present embodiment, the image processing apparatus 102 is configured to obtain the amount of blur of the object on a basis of the amount of movement of the approximate shape corresponding to the object and set a learning model having a decreased learning parameter number per volume to a learning target region including an object of a large amount of blur. The image processing apparatus 102 is configured to set, in contrast, a learning model having an increased learning parameter number per volume to a learning target region including an object of a small amount of blur. The image processing apparatus 102, which is configured in this manner, makes it possible to restrict the amount of computation needed to estimate the three-dimensional information for generating a virtual viewpoint image having a perceived resolution at the same level of the captured images and restrict the amount of information of the three-dimensional information. In particular, the image processing apparatus 102 makes it possible to generate a virtual viewpoint image having a perceived resolution at the same level of the captured images while restricting the amount of computation needed to estimate the three-dimensional information and the amount of information of the three-dimensional information even in a case where an object of a large amount of blur is present.

### Modifications of First Embodiment

The first embodiment has been described on the assumption that the shape obtaining unit 302 obtains, in the process of S402, the approximate shape of the object 107 according to the visual hull. However, how to obtain the approximate shape of the object 107 is not limited to this. For example, the shape obtaining unit 302 may obtain the approximate shape of the object 107 on a basis of distance information obtained through stereo matching or the like using captured images obtained by the image obtaining unit 301 or on a basis of range images from depth cameras. Alternatively, information that represents the approximate shape of the object 107 and is generated in advance may be stored in the storage device 204 or the like, and the shape obtaining unit 302 may read out the information to obtain the approximate shape of the object 107.

The first embodiment has been described on the assumption that the amount-of-blur obtaining unit 303 calculates, in the process of S702, the amount of movement of the approximate shape in the frame of interest using the frame of interest and the frame immediately preceding the frame of interest. However, the amount of movement of the approximate shape in the frame of interest may be calculated using, for example, the frame of interest and a frame immediately following the frame of interest. Alternatively, for example, the amount of movement of the approximate shape in the frame of interest may be calculated using the frame immediately preceding the frame of interest and the frame immediately following the frame of interest.

The first embodiment has been described on the assumption that the amount-of-blur obtaining unit 303 obtains, in the process of S403, the amount of blur of the object on a basis of the amounts of movement of the approximate shape on the captured images. However, the amount of blur of the object may be obtained on a basis of a three-dimensional amount of movement of the approximate shape. In this case, for example, regarding the coordinates of the center of gravity of the approximate shape as a reference point, the amount-of-blur obtaining unit 303 first calculates the magnitude of a movement vector from the reference point in the previous frame to the reference point to the frame of interest and takes the magnitude as the three-dimensional amount of movement of the approximate shape. The amount-of-blur obtaining unit 303 then calculates and obtains a three-dimensional amount of movement of the approximate shape per exposure time, as the amount of blur of the object. Afterward, the model setting unit 304 sets the learning model using a look-up table that corresponds to amounts of blur of the object based on three-dimensional amounts of movement of the approximate shape.

Alternatively, for example, the amount-of-blur obtaining unit 303 may obtain the amount of blur of the object on a basis of the amount of movement of a region that is extracted from captured images and corresponds to the object (hereinafter, will be referred to as “object region”). In this case, for example, the amount-of-blur obtaining unit 303 first obtains an object region corresponding to the object 107 on a basis of the differences between the captured images and background images and takes the position of the center of gravity of an object of interest as a reference point. The amount-of-blur obtaining unit 303 then calculates the length from the reference point in the previous frame to the reference point in the frame of interest using, for example, Equation (3) and takes the length as the amount of movement of the object region. The amount-of-blur obtaining unit 303 then obtains the amount of blur of the object based on the amount of movement of the object region using, for example, Equation (4).

Alternatively, for example, the amount-of-blur obtaining unit 303 may obtain the amount of blur of the object on a basis of pixel values of the object region in the captured images. For example, markers in a black and white checkered pattern or the like are placed in advance on some portions of the object, and the amount-of-blur obtaining unit 303 obtains a line spread function (LSF) on a basis of the pixel values of a region corresponding to the markers extracted from the object region. The amount-of-blur obtaining unit 303 obtains the amount of blur of the object on a basis of the spread of the LSF. Alternatively, for example, the amount-of-blur obtaining unit 303 may obtain the amount of blur on a basis of high-contrast texture included in the object, instead of the markers.

The first embodiment has been described on the assumption that the model setting unit 304 sets, in the process of S404, one learning model to one object 107. However, one learning model may be set to each of a plurality of objects. In a case where a plurality of objects that are not in contact with one another are present in the image capturing region, first, for example, the shape obtaining unit 302 performs, in S402, the visual hull or the like to obtain a plurality of sets of voxels corresponding to the objects as a plurality of approximate shapes. Then, in S403, for example, the amount-of-blur obtaining unit 303 obtains the amounts of blur corresponding to the plurality of objects. Specifically, for example, first, the amount-of-blur obtaining unit 303 sets, in S701, a reference point to each of the plurality of approximate shapes. After S701, in S702, the amount-of-blur obtaining unit 303 calculates the amount of movement for each of the plurality of approximate shapes. For example, the amount-of-blur obtaining unit 303 calculates the smallest values of the lengths from the reference points of the approximate shapes in the frame of interest (hereinafter, will be referred to as “shapes of interest”) to the reference points in the previous frame using Equation (5) and takes the values as the amounts of movement of the shapes of interest.

$${m}_{i , j , k} = {min}_{{k}^{′}} ( \vert {p}_{i , j , k} - {p}_{i - 1 , j , {k}^{′}} \vert ) \qquad Equation ( 5 )$$

Here, m_{i,j,k} denotes the amounts of movement of the shapes of interest in the frame of interest corresponding to the image capturing device j. In addition, p_{i,j,k} denotes the coordinates of a point at which the reference point of a shape k of interest in the frame i is projected to the image capturing device j, and p_{i-1,j,k} denotes the coordinates of a point at which the reference point of an approximate shape k′ in the previous frame is projected to the image capturing device j. Then, in S703, the amount-of-blur obtaining unit 303 calculates the amounts of blur corresponding to the plurality of objects using, for example, Equation (4) to obtain the amounts of blur of the objects.

After S403, in S404, the model setting unit 304 sets learning models to spaces including the plurality of objects. Specifically, for example, in S901, the model setting unit 304 sets, for each of the plurality of objects, a rectangular cuboid shape containing its approximate shape as the learning target region. Then, in S902, the model setting unit 304 sets a learning parameter number per volume in the learning model corresponding to each of the plurality of objects on a basis of the amount of blur of the object. Then, in S903, the model setting unit 304 sets, for each of the plurality of objects, the learning model to which the learning parameter number per volume is set in S902 to the learning target region that is set in S901.

The first embodiment has been described on the assumption that the amount-of-blur obtaining unit 303 specifies, in the process of S702, an image capturing device 101 that includes the reference point in the angle of view. However, the amount-of-blur obtaining unit 303 may specify an image capturing device 101 that includes the reference point in the angle of view and from which the reference point is not occluded. Here, for example, the amount-of-blur obtaining unit 303 judges that the reference point is not occluded in a case where the approximate shape of another object not including the reference point is absent between the reference point and the image capturing device 101.

The first embodiment has been described on the assumption that the model setting unit 304 controls, in the process of S404, the total number of layers in the intermediate layer of the MLP. However, the number of nodes per layer in the intermediate layer of the MLP may be controlled. For example, the model setting unit 304 sets a learning model such that its number of nodes per layer in the intermediate layer of its MLP is increased with an increase in pixel resolution, and sets a learning model such that its number of nodes is decreased with a decrease in pixel resolution.

The first embodiment has been described on the assumption that the model setting unit 304 sets, in the process of S404, the learning model constituted by the MLP to the learning target region. However, the constitution of the learning model is not limited to this. For example, the model setting unit 304 may set, to the learning target region, a learning model configured with a plurality of learning parameters that are arranged in a grid pattern at predetermined intervals in the three-dimensional space. Specifically, for example, the model setting unit 304 may set, to the learning target region, a learning model that represents the radiance fields of the space on a basis of a plurality of spherical harmonics that are arranged in a grid pattern.

The learning model set to the learning target region by the model setting unit 304 is not limited to this. For example, the model setting unit 304 may set, to the learning target region, a learning model that represents the radiance fields of the space on a basis of a matrix with a predetermined number of components each having an element corresponding to a grid, a set of vectors, or the like. In this case, for example, the model setting unit 304 sets, to the learning target region, a learning model such that the number of grids per volume increases, that is, a grid spacing decreases, with an increase in pixel resolution. The model setting unit 304 may set, to the learning target region, a learning model such that a learning parameter number per grid increases with an increase in pixel resolution. Here, the learning parameter number per grid is equivalent to the number of coefficients of spherical harmonics or the number of components.

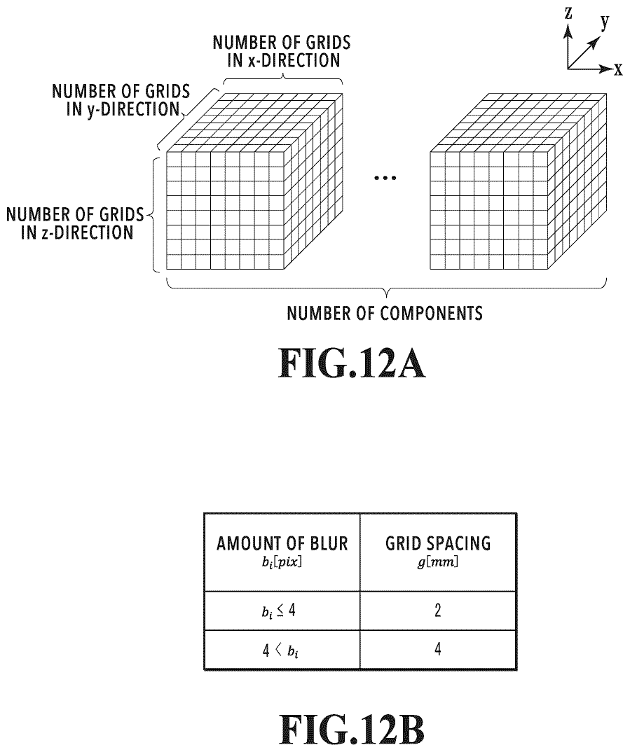

FIGS. 12A and 12B are a diagram and a table for describing an example of the process of setting the learning model by the model setting unit 304 according to a modification of the first embodiment. Specifically, FIG. 12A is a diagram illustrating an example of grids and components according to the modification of the first embodiment. For example, the model setting unit 304 sets, to the learning target region, a learning model such that the grid spacing decreases with a decrease in the amount of blur bᵢ, and associates the learning model with a component area. FIG. 12B shows an example of a look-up table used by the model setting unit 304 to determine the grid spacing. For example, as in the look-up table shown in FIG. 12B as an example, the associations between amounts of blur bᵢ and grid spacings are defined in advance. The model setting unit 304 first determines a grid spacing corresponding to an amount of blur bᵢ using the look-up table. The model setting unit 304 then determines the number of grids on a basis of values obtained by dividing the lengths of the sides of the learning target region by the grid spacing.

The first embodiment has been described on the assumption that the model setting unit 304 selectively sets, in the process of S902, any one of the two values as the number of layers per volume in the intermediate layer of the density MLP corresponding to the learning target region. However, the model setting unit 304 may selectively set any one of three or more values.

The first embodiment has been described on the assumption that the image processing apparatus 102 performs the learning of the learning model that represents the radiance fields. However, the learning model to be subjected to the learning is not limited to a learning model representing the radiance fields. The learning model may be any learning model representing three-dimensional information that can be learned on a basis of the captured image data items. For example, the three-dimensional information is not limited to radiance fields, which represent a color and a density in accordance with a position and a direction.

Specifically, for example, the three-dimensional information may be three-dimensional information that represents a color corresponding to a position in the space in the three-dimensional information in the form of an isotropic color, which is independent of direction. Alternatively, for example, the three-dimensional information may be three-dimensional information that represents a density corresponding to a position in the space in the three-dimensional information in the form of a signed distance field, which represents the distance to an object surface corresponding to the position. Alternatively, for example, the three-dimensional information may be three-dimensional information that represents a density field representing a density corresponding to a position, a field represented by a bidirectional reflectance distribution function representing distribution characteristics of reflected light with respect to incident light, a field representing the light visibility of ambient light, or the like. Alternatively, the three-dimensional information may be three-dimensional information that represents a field representing a color and a density corresponding to a position, a direction, and a time. In this case, captured image data used for the learning of the three-dimensional information is data on a moving image including time-series frames.

### Second Embodiment

In the first embodiment, an aspect in which the learning parameter number per volume is set on a basis of the amount of blur of an object has been described. In the present embodiment, an aspect in which the learning parameter number per length is set for each of a plurality of direction on a basis of a plurality of amounts of blur corresponding to the plurality of directions will be described. Specifically, a model setting unit 304 according to the second embodiment sets, to a learning target region, a learning model such that the learning parameter number corresponding to a direction of a small amount of blur increases, and the learning parameter number corresponding to a direction of a large amount of blur decreases. This makes it possible to selectively reduce the learning parameter number only in a direction in which the amount of blur is large.

With reference to FIGS. 2 to 4 and FIGS. 13 to 17, an image processing apparatus 102 according to the second embodiment (hereinafter, will be simply denoted as “image processing apparatus 102”) will be described. The image processing apparatus 102 has the hardware configuration and the functional configuration as illustrated in the block diagrams in FIGS. 2 and 3 as an example, respectively, as with the image processing apparatus 102 according to the first embodiment. The image processing apparatus 102 executes the processes in the flowchart illustrated in FIG. 4 as an example, as with the image processing apparatus 102 according to the first embodiment. Note that processes by an amount-of-blur obtaining unit 303 and a model setting unit 304 in the present embodiment differ from processes by the amount-of-blur obtaining unit 303 and the model setting unit 304 according to the first embodiment. That is, the process of obtaining amounts of blur in S403 and the process of setting a learning model in S404 according to the present embodiment differ from the processes of S403 and S404 according to the first embodiment.

Specifically, the amount-of-blur obtaining unit 303 according to the first embodiment obtains, in the process of obtaining the amount of blur in S403, one amount of blur of an object on a basis of the largest amount of movement of the amounts of movement of the approximate shape corresponding to the image capturing devices. In contrast, the amount-of-blur obtaining unit 303 according to the present embodiment obtains a plurality of amounts of blur corresponding to a plurality of directions on a basis of a three-dimensional movement vector of the approximate shape. On a basis of the plurality of amounts of blur corresponding to the plurality of directions obtained by the amount-of-blur obtaining unit 303, the model setting unit 304 according to the present embodiment sets, to a learning target region including an object, a learning model configured with learning parameters arranged in a grid pattern. In the present embodiment, the process of obtaining the amounts of blur by the amount-of-blur obtaining unit 303 and the process of setting the learning model by the model setting unit 304, which are different from the corresponding processes in the first embodiment, will be mainly described below. Note that components or processing steps (processes) performing the same processes as in the first embodiment will be denoted by identical reference characters, and the descriptions thereof will be omitted.

### <Process of Obtaining Amount of Blur>

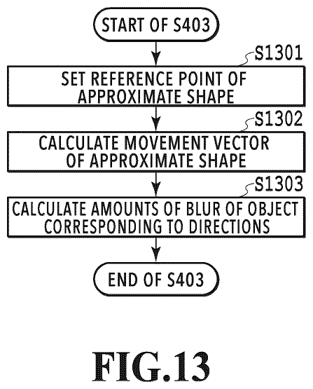

FIG. 13 is a flowchart illustrating an example of the flow of the process of obtaining amounts of blur by the amount-of-blur obtaining unit 303 according to the second embodiment. FIG. 13 is a flowchart illustrating an example of a detailed processing flow of S403 illustrated in FIG. 4. The processes in the flowchart are executed after the process of S402 illustrated in FIG. 4. In the process of S403 according to the second embodiment, the plurality of amounts of blur corresponding to the plurality of directions are obtained on a basis of a three-dimensional movement vector of the approximate shape.

After S402, first, in S1301, the amount-of-blur obtaining unit 303 sets a reference point to the approximate shape of the object obtained in S402, as in S701 according to the first embodiment. Next, in S1302, the amount-of-blur obtaining unit 303 calculates the movement vector of the approximate shape using the reference point set in S1301. Specifically, for example, the amount-of-blur obtaining unit 303 calculates the movement vector of the approximate shape using the position of the reference point of the approximate shape in a frame of interest and the position of the reference point of the approximate shape in a previous frame. For example, the amount-of-blur obtaining unit 303 calculates a vector from the reference point in the previous frame to the reference point in the frame of interest using Equation (6) and takes the vector as the movement vector of the approximate shape.

$${m}_{i}^{′} = {p}_{i}^{′} - {p}_{i - 1}^{′} \qquad Equation ( 6 )$$

Here, m′ᵢ denotes a movement vector of the approximate shape in a frame i, which is the frame of interest, p′ᵢ denotes the coordinates of the reference point in the frame i, and p′ᵢ₋₁ denotes the coordinates of the reference point, in a frame i−1, which is the previous frame.

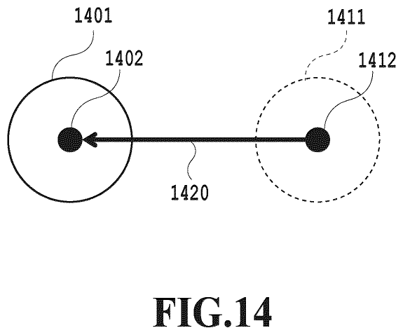

FIG. 14 is a diagram illustrating an example of the movement vector of the approximate shape according to the second embodiment. In FIG. 14, the circle of a solid line indicates an example of an approximate shape 1401 of an object corresponding to the frame of interest, and the point inside the approximate shape 1401 of the object indicates an example of a reference point 1402 of the approximate shape 1401. The circle of a broken line indicates an example of an approximate shape 1411 of an object corresponding to the previous frame, and the point inside the approximate shape 1411 of the object indicates an example of a reference point 1412 of the approximate shape 1411. The arrow extending from the reference point 1412 to the reference point 1402 indicates a movement vector 1420 of the approximate shape of the object corresponding to the frame of interest.

After S1302, in S1303, the amount-of-blur obtaining unit 303 calculates the amount of blur of the object corresponding to each of the directions on a basis of the movement vector of the approximate shape of the object calculated in S1302. For example, the amount-of-blur obtaining unit 303 calculates the amounts of movement per exposure time of the approximate shape projected in an x-direction, a y-direction, and a z-direction that define the three-dimensional space including the object 107 by using Equations (7) to (9), and takes the amounts of movement as the amounts of blur of the object corresponding to the directions.

$${b}_{i , x}^{′} = s f \vert {m}_{i}^{′} \cdot {e}_{x} \vert \qquad Equation ( 7 )$$

$${b}_{i , y}^{′} = s f \vert {m}_{i}^{′} \cdot {e}_{y} \vert \qquad Equation ( 8 )$$

$${b}_{i , z}^{′} = s f \vert {m}_{i}^{′} \cdot {e}_{z} \vert \qquad Equation ( 9 )$$

Here, b′_{i,x}, b′_{i,y}, and b′_{i,z} denote the amounts of blur of the object corresponding to an x-direction, a y-direction, and a z-direction in the frame i, which is the frame of interest, in this order. In addition, s denotes the exposure time of a captured image, f denotes the frame rate of the captured image, and e′ₓ, e′_{y}, and e′_{z} denote unit vectors in the x-direction, the y-direction, and the z-direction, in this order. After S1303, the amount-of-blur obtaining unit 303 finishes the processes in the flowchart illustrated in FIG. 13, that is, the process of S403 illustrated in FIG. 4. Through the processes, the amount-of-blur obtaining unit 303 obtains the amounts of blur corresponding to the directions in the frame of interest.

### <Process of Setting Learning Model>

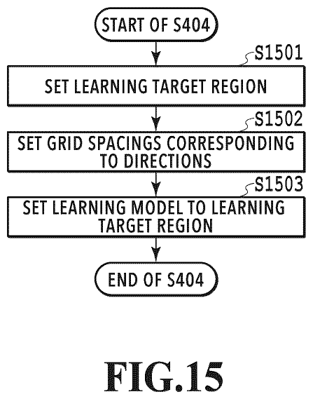

FIG. 15 is a flowchart illustrating an example of the flow of the process of setting a learning model by the model setting unit 304 according to the second embodiment. FIG. 15 is a flowchart illustrating an example of a detailed processing flow of S404 illustrated in FIG. 4. The processes in the flowchart are executed after the process of S403 according to the present embodiment. In the process of S404 according to the second embodiment, the learning model corresponding to the object is set on a basis of the approximate shape of the object obtained in S402 and the amounts of blur corresponding to the directions obtained in S403. The present embodiment will be described on the assumption that, as an example, the model setting unit 304 sets, as the process of setting the learning model, a learning model configured with learning parameters arranged in a grid pattern in the three-dimensional space illustrated in FIG. 12A as an example. Specifically, the present embodiment will be described on the assumption that, as an example, the model setting unit 304 controls grid spacings of the learning model in accordance with the amounts of blur corresponding to the directions.

After S403, in S1501, the model setting unit 304 sets, as a learning target region, the region of a rectangular cuboid shape containing the approximate shape of the object obtained in S402, as in S901 according to the first embodiment. Next, in S1502, the model setting unit 304 sets the grid spacings corresponding to the plurality of directions in the learning model corresponding to the object on a basis of the amounts of blur corresponding to the directions obtained in S403. Specifically, for example, the model setting unit 304 sets the grid spacings of the learning model such that a grid spacing in an l direction that represents any one of the x-direction, the y-direction, and the z-direction decreases with a decrease in an amount of blur b′_{i,l}, which corresponds to the l direction. For example, the model setting unit 304 consults a look-up table in which amounts of blur are associated in advance with grid spacings in the learning model. Using the look-up table, the model setting unit 304 determines the grid spacings of the learning model in accordance with the amounts of blur of the object. For example, an object for which the amount of blur b′_{i,l} is less than or equal to a predetermined value is defined in advance as an object of a small amount of blur, and an object for which the amount of blur b′_{i,l} is greater than the predetermined value is defined in advance as an object of a large amount of blur.

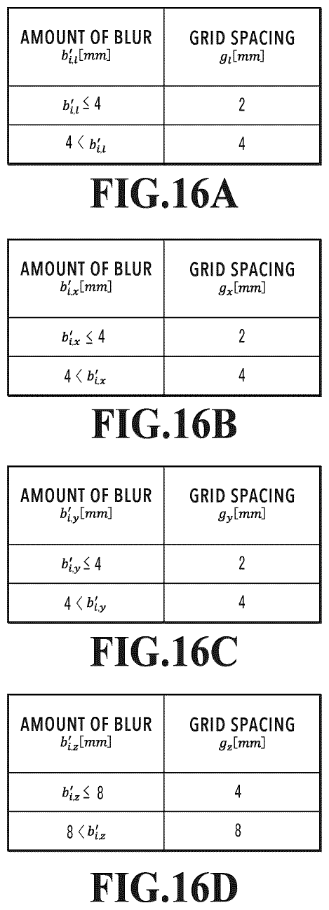

FIGS. 16A to 16D are tables showing examples of the look-up table used by the model setting unit 304 according to the second embodiment to determine the grid spacings. For example, an object for which the amount of blur b′_{i,l} is less than or equal to 4 pix is defined in advance as an object of a small amount of blur, and an object for which the amount of blur b′_{i,l} is greater than 4 pix is defined in advance as an object of a large amount of blur. FIG. 16A shows an example of the look-up table in a case where the plurality of directions are treated equally. FIGS. 16B to 16D will be described later. As illustrated in FIG. 16A as an example, the model setting unit 304 sets a small value such as “2 mm (millimeters)” as the grid spacing of a learning model corresponding to an object for which the amount of blur b′_{i,l} is less than or equal to 4 pix, that is, an object of a small amount of blur. The model setting unit 304 sets a large value such as “4 mm” as the grid spacing of a learning model corresponding to an object for which the amount of blur b′_{i,l} is greater than 4 pix, that is, an object of a large amount of blur.

The model setting unit 304 performs the same process for the x-direction, the y-direction, and the z-direction to set a grid spacing in the x-direction, a grid spacing in the y-direction, and a grid spacing in the z-direction in the learning model. As seen from the above, the model setting unit 304 selectively sets any one of the two values as the grid spacings in the directions in the learning model in accordance with the amounts of blur corresponding to the directions.

After S1502, in S1503, the model setting unit 304 sets the learning model to the learning target region set in S1501 on a basis of the grid spacings corresponding to the directions set in S1502. Specifically, the model setting unit 304 sets the numbers of grids in the directions in the learning model on a basis of values obtained by dividing the lengths of the sides of a rectangular cuboid shape representing the learning target region by the grid spacings in the corresponding directions. The model setting unit 304 then sets, in accordance with the set grid spacings and the set numbers of grids, the learning model configured with learning parameters arranged in a grid pattern to the learning target region. After S1503, the model setting unit 304 finishes the processes in the flowchart illustrated in FIG. 15, that is, the process of S404 according to the second embodiment.

Through the process of S404, to the learning target region corresponding to the object of a small amount of blur, a learning model with small grid spacings, that is, a learning model in which the learning parameter numbers per length in all the directions are large, is set. To the learning target region corresponding to the object of a large amount of blur, a learning model with a large grid spacing corresponding to a direction of a large amount of blur, that is, a learning model in which the learning parameter number per length in the direction of a large amount of blur is small, is set.

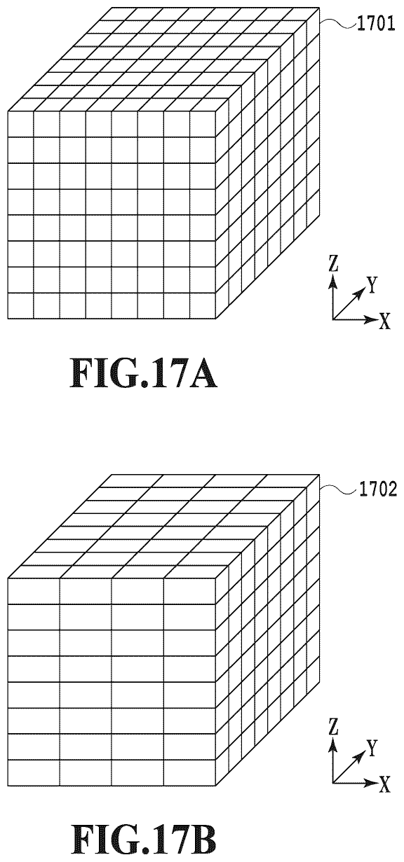

FIGS. 17A and 17B are diagrams for describing an example of the process of setting the learning model by the model setting unit according to a modification of the second embodiment. Specifically, FIG. 17A illustrates a learning target region 1701 that corresponds to an object for which the amount of movement of the approximate shape is small, that is, an object of a small amount of blur. To the learning target region 1701, a learning model in which grid spacings in all the directions are small is set. FIG. 17B illustrates a learning target region 1702 corresponding to an object for which the amount of movement of the approximate shape is large in only the x-direction, that is, an object for which the amount of blur is large in only the x-direction. To the learning target region 1702, a learning model in which only a grid spacing in the x-direction is large is set.

In the learning target region 1701 corresponding to the object of a small amount of blur, the learning parameter numbers per length are large in all the directions. Thus, the radiance fields, that is, the three-dimensional information may be estimated at a high resolution. In this case, the representation of an object included in a virtual viewpoint image generated on a basis of the three-dimensional information is of a high resolution as with the representations of an object of a small amount of blur included in the captured images. In the learning target region 1702 corresponding to the object for which the amount of blur is large in only the x-direction, the learning parameter number per length is small in only the x-direction. Thus, the amount of computation needed to estimate the three-dimensional information and the amount of information of the three-dimensional information may be restricted. In this case, the representation of an object included in a virtual viewpoint image generated on a basis of the three-dimensional information is of a low resolution in only the x-direction as with the representations of an object included in the captured images with a large amount of blur only in the x-direction.

### <Effects Produced by Image Processing Apparatus According to Second Embodiment>

As described above, in the second embodiment, the image processing apparatus 102 is configured to obtain the amounts of blur of an object corresponding to the directions and set a learning model to a learning target region on a basis of the amounts of blur corresponding to the directions. In particular, the image processing apparatus 102 is configured to obtain amounts of blur of an object corresponding to the directions on a basis of a three-dimensional movement vector of an approximate shape corresponding to the object. The image processing apparatus 102 is also configured to set a learning model having a decreased learning parameter number per length for a direction of a large amount of blur of the object, to a learning target region including an object. In contrast, the image processing apparatus 102 is configured to set a learning model having an increased learning parameter number per length for a direction of a small amount of blur of the object, to a learning target region including an object.

The image processing apparatus 102, which is configured in this manner, makes it possible to restrict the amount of computation needed to estimate the three-dimensional information for generating a virtual viewpoint image having a perceived resolution at the same level of the captured images and restrict the amount of information of the three-dimensional information, for each direction. In particular, even in a case where an object of a large amount of blur is included, the image processing apparatus 102 may restrict the amount of computation needed to estimate the three-dimensional information and the amount of information of the three-dimensional information that correspond to a direction of a large amount of blur. In addition, by using the three-dimensional information estimated in this manner, a virtual viewpoint image having a perceived resolution at the same level of the captured images may be generated.

### Modification of Second Embodiment

The model setting unit 304 according to the second embodiment has been described as selecting and determining, in the process of S1502, any one of the two values as the grid spacings corresponding to the plurality of directions corresponding to a learning target region. However, the model setting unit 304 may select and determine the grid spacings from any one of three or more values.

The model setting unit 304 according to the second embodiment has been described as setting, in the process of S1502, the grid spacings corresponding to the directions using a common look-up table irrespective of the directions. However, the model setting unit 304 may set the grid spacings corresponding to the directions using different look-up tables in accordance with the directions. FIGS. 16B to 16D show examples of look-up tables used by the model setting unit 304 to determine the grid spacing and corresponding to the x-direction, the y-direction, and the z-direction that define the three-dimensional space, in this order. For example, by using the look-up tables corresponding to the x-direction, the y-direction, and the z-direction illustrated in FIGS. 16B to 16D as examples, the model setting unit 304 determines the grid spacings for the directions on a basis of the amounts of blur of an object corresponding to the directions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-17096, filed Feb. 4, 2025, which is hereby incorporated by reference herein in its entirety.

What is claimed is:

1. An image processing apparatus, comprising:
one or more hardware processors; and
one or more memories storing one or more programs configured to be executed by the one or more hardware processors, the one or more programs including instructions for:
obtaining a plurality of captured images obtained by performing image capturing on an object from a plurality of directions;
obtaining an amount of blur of the object;
setting a learning model on a basis of the amount of blur of the object, the learning model representing three-dimensional information on the object; and
performing learning of the learning model using the captured images.

2. The image processing apparatus according to claim 1, wherein the one or more programs further include instructions for:
setting the learning model such that, in a case where the amount of blur of the object is large, a learning parameter number per volume becomes small compared with a case where the amount of blur of the object is small.

3. The image processing apparatus according to claim 1, wherein the one or more programs further include instructions for:
obtaining an approximate shape of the object; and
obtaining the amount of blur of the object on a basis of amounts of movement of the approximate shape on the captured images per exposure time in the image capturing.

4. The image processing apparatus according to claim 3, wherein the one or more programs further include instructions for:
obtaining the amount of blur of the object on a basis of amounts of movement of the approximate shape on image planes corresponding to the captured images.

5. The image processing apparatus according to claim 3, wherein the one or more programs further include instructions for:
obtaining the amount of blur of the object on a basis of a three-dimensional amount of movement of the approximate shape.

6. The image processing apparatus according to claim 5, wherein the one or more programs further include instructions for:
obtaining the amount of blur of the object in each of a plurality of directions on a basis of a three-dimensional amount of movement of the approximate shape; and
setting the learning model such that, in a case where the amount of blur of the object corresponding to a direction is large, a learning parameter number per length corresponding to the direction becomes small compared with a case where the amount of blur of the object corresponding to the direction is small.

7. The image processing apparatus according to claim 1, wherein the one or more programs further include instructions for:
extracting an object region corresponding to the object from the captured images; and
obtaining an amount of blur of the object on a basis of the object region.

8. The image processing apparatus according to claim 7, wherein the one or more programs further include instructions for:
obtaining the amount of blur of the object on a basis of amounts of movement of the object region on the captured images per exposure time in the image capturing.

9. The image processing apparatus according to claim 7, wherein the one or more programs further include instructions for:
obtaining the amount of blur of the object on a basis of pixel values of the object region in the captured images.

10. The image processing apparatus according to claim 1, wherein the one or more programs further include instructions for:
obtaining information about a virtual viewpoint; and
generating a virtual viewpoint image corresponding to the virtual viewpoint by using the learning model subjected to the learning.

11. An image processing method comprising the steps of:
obtaining a plurality of captured images obtained by performing image capturing on an object from a plurality of directions;
obtaining an amount of blur of the object;
setting a learning model on a basis of the amount of blur of the object, the learning model representing three-dimensional information on the object; and
performing learning of the learning model using the captured images.

12. A non-transitory computer readable storage medium storing a program for causing a computer to perform a control method of an image processing apparatus, the control method comprising the steps of:
obtaining a plurality of captured images obtained by performing image capturing on an object from a plurality of directions;
obtaining an amount of blur of the object;
setting a learning model on a basis of the amount of blur of the object, the learning model representing three-dimensional information on the object; and
performing learning of the learning model using the captured images.
